(19) United States
(12) Patent Application Publication
(10) Pub. No.: US 2004/0238790 A1
(43) Pub. Date: Dec. 2, 2004

(54) Stabilization of luminescence from organic materials with compounds of phenolic origin

(76) Inventors: Giuseppe Baldacchini, Frascati (IT); Rosa Maria Montereali, Frascati (IT); Angelo Pace, Frascati (IT); Serena Gagliardi, Frascati (IT); Ramchandra Pode, Nagpur (IN); Tommaso Baldacchini, Grottaferrata (IT)

Correspondence Address: BROWDY AND NEIMARK, P.L.L.C., 624 NINTH STREET, NW, SUITE 300, WASHINGTON, DC, 20001-5303, US

(21) Appl. No.: 10/485,470

(22) PCT Filed: Jul. 30, 2002
(86) PCT No.: PCT/IT02/00504

(30) Foreign Application Priority Data
Aug. 2, 2001 (IT) RM2001A000471

(51) Int. Cl. C09K 11/06; H05B 33/14

(52) U.S. Cl. 252/301.16; 428/690; 428/917; 252/301.35; 313/504

(57) ABSTRACT

The invention relates to the use of compounds of phenolic origin for the stabilization of the luminescence from organic for the stabilization of the luminescence from organic materials and a process for the stabilization itself.

The present invention relates to the use of compounds of phenolic origin for the stabilization of the luminescence from organic materials, as well as to a process for the stabilization itself and devices which utilize stabilized organic materials to obtain luminescence.

Since classic ancient times it was known that some organic substances emitted light if properly stimulated by the surrounding environment, but only in the last century the study of the light phenomena in these materials has assumed a remarkable scientific dimension, until coming to the use thereof in the modern optoelectronic devices around 1960. For instance, organic dye lasers still today are used in many scientific laboratories. In parallel with photoluminescence, light emission induced by optical pumping, also electroluminescence, emission induced by electric current, having in mind also application typologies of common use such as video displays.

But only more recently important results have been obtained with organic materials which have justified the efforts and researches for the practical use thereof. In particular molecular organic compounds have drawn the experts' attention in 1987, whereas the polymeric organic materials have been developed after 1990. Equivalent devices which utilized semiconducting inorganic materials, just to make an example, were already well known around 1970. Notwithstanding this great delay, organic materials have had a very quick development and now they are practically able to compete with inorganic materials in terms of functional performances and in particular of light emission efficiency. Even with these successful expectations of industrial applicability, the problem which up to now has delayed the use thereof has been the light emission efficiency which decreases appreciably in time.

Therefore, it was felt in the state of art the need for luminescent organic materials having a light efficiency prolonged in time.

It has been now surprisingly found that the use of compounds of phenolic nature together with luminescent organic materials prevents the degradation thereof and above all it prolongs the lasting of the luminescence.

Therefore it is an object of the present invention the use of compounds of phenolic origin for the stabilization of luminescence from organic materials. The compounds of phenolic origin are substantially used together with the organic materials in quantities ranging from 1 to 10% in weight by referring to the weight of the organic materials.

### BRIEF DESCRIPTION OF THE DRAWINGS

Ten figures are enclosed with the description, showing:

FIG. 1 the absorption and emission spectrum of Alq₃ with pumping at λ=395 nm;

FIGS. 2 and 3, respectively, the two isomers of Alq₃ and the formula of BHT;

FIG. 4 a schematic structure of an OLED device;

FIGS. 5a, b and c the structure of the samples used in the present description;

FIG. 6 a graph of the optical density of an Alq₃ sample vs. the wavelength and at two different times;

FIG. 7 a graph analogous to the one of FIG. 6, wherein a BHT layer has been added;

FIG. 8 a graph of the photoluminescence of pure Alq₃ vs. the wavelength at various times;

FIG. 9 a graph of the emission intensity at 528 nm for 1000 hours of three different samples containing pure Alq₃ and BHT;

FIG. 10 a graph analogous to the one of FIG. 9 for 200 hours.

In the scope of the present invention all those compounds having one or more hydroxyl groups directly bonded to an aromatic ring are referred to as compounds of phenolic origin.

Under the term organic materials which produce luminescence, both organic molecules and organic polymers able to produce luminescence under excitation of physical and/or chemical nature are meant.

Among the materials the luminescence thereof is stabilized by compounds of phenolic origin according to the invention there can be mentioned: tetracene, anthracene, carbazole, rubrene, TBD, PKV, DMC, α-6T, Er(TTA)3(phen), Alq₃ among the molecules and P3AT, PPA, PPV, CN-PPV, MEH-PPV, RO-PPV, PPy, PT, PTV, PVK, SiPhPVK among the polymers. Among the mentioned materials the compound Tris(8-hydroxyquinoline)aluminum indicated as Alq₃ is considered particularly preferred.

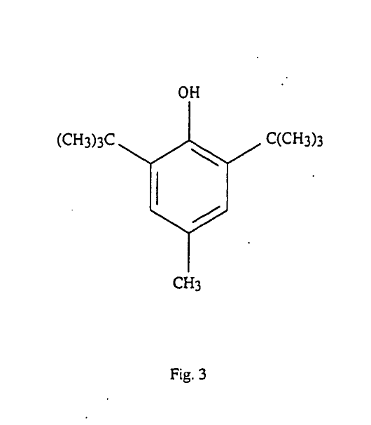

Instead, as far as the compounds of phenolic origin are concerned, the choice can fall on a particularly considerable series of compounds among thereof there can be mentioned: phenol, vanillin, L-tyrosine, BHA, BHT, E vitamin, propyl gallate, 2,4,6-tri-t-butylphenol, hydroxytyrosole, caffeic acid. Within the scope of the present invention, the use of the compound called butylated hydroxytoluene (commonly known as BHT, see FIG. 3), molecule having two tert-butyl groups C(CH₃)₃, able to stabilize more and better than phenol the free electron in the benzene ring, has demonstrated particularly advantageous. BHT is a product well known as antioxidant and it is utilized in petrol, lubricant oils, gums and food products, even if recently the use thereof as food product preservative has stopped since it has resulted to be dangerous to human health.

Advantageously, according to the present invention compounds of phenolic origin not having absorption bands in the same spectral region of the organic material the luminescence thereof has to be stabilized, are used.

An additional object of the present invention is a process for the stabilization of the luminescence from organic materials comprising the following steps:

a. mixing of said organic material with a quantity ranging from 1 to 10% by weight of a compound of phenolic origin until obtaining a homogeneous composite material

b. use of said homogeneous composite material for obtaining luminescence.

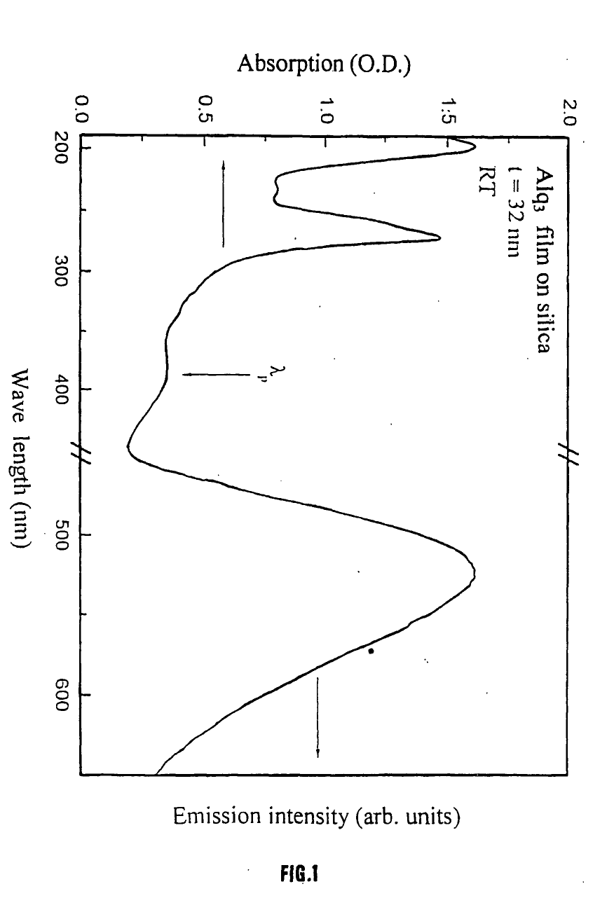

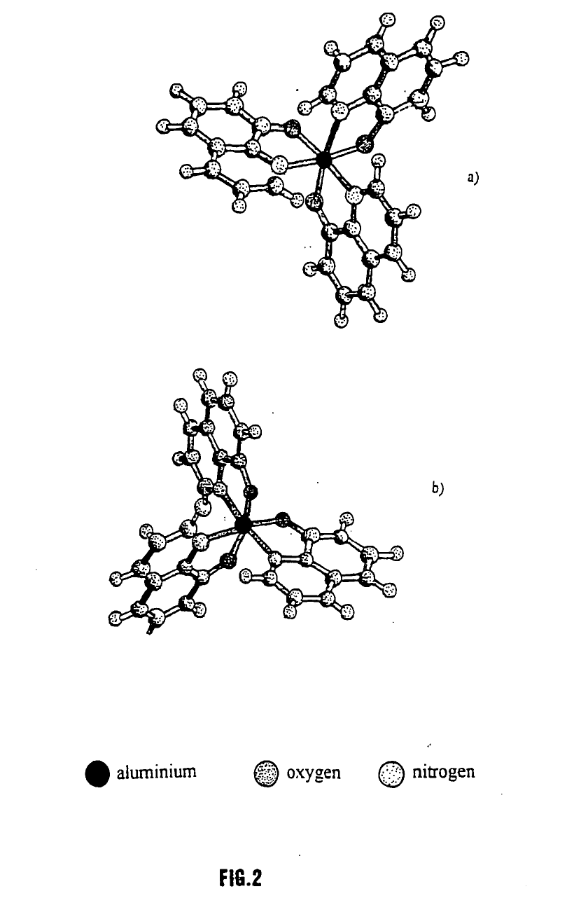

In the following examples a molecule called tris(8-hydroxyquinoline)aluminum, indicated Alq₃ (see FIG. 2), belonging to the metal chelate family, will be in particular referred to, although the prolongation of the lasting of the luminescence can be obtained in all luminescent organic compounds, both molecules and polymers, utilized according to the invention together with compounds of phenolic origin. The compound Alq₃ is very used nowadays in the organic light-emitting diodes (OLED) and it has different absorption bands at wavelengths lower than 450 nm, which properly excited produce a single emission band in the green around 540 nm. FIG. 1 shows the absorption and emission spectra with pumping at λp=395 nm of a 28 nm-thick Alq₃ film at room temperature. The luminescence in the green is the one usually utilized in the OLED devices which are already very widespread, even if the basic spectroscopic properties thereof are not yet very well known. Anyway, as previously said, even if having great potentiality, this material has a practical use limited by the fact that the average life thereof, defined as the time required to halve the emission intensity, in simple OLED devices rarely exceeds some hours. Some solutions have been proposed aimed at minimizing or avoiding the degradation causes such as, for example, avoiding contact with water and oxygen in the atmosphere by encapsulating the devices in inert gas or in vacuum. However, notwithstanding these efforts, devices able to exceed 5,000 hours are rarely obtained.

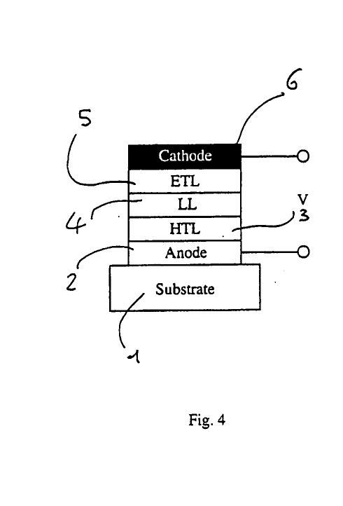

The scheme of a typical OLED device is shown in FIG. 4, wherein 1 represents the substrate, 2 the anode and 6 the cathode, 3 (indicated also as HTL) is a layer which easily transports holes, 4 (indicated also LL) is the luminescent layer and 5 (indicated also ETL) is a layer which easily transports electrons.

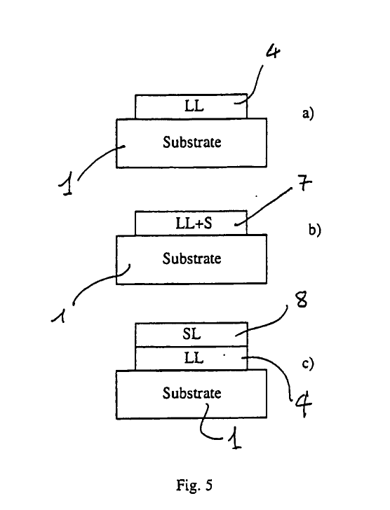

In order to demonstrate the stabilization of the luminescence from organic materials by means of compounds of phenolic origin, object of the present invention, the studies performed on different samples (the structure thereof is schematically shown in FIG. 5a, b, c) are reported. In this case one has chosen to work on devices constituted by the single layer of luminescent material or, at most, by two layers the second thereof having a protective function. In FIG. 5a, b and c 1 represents the substrate, 4 (LL) the luminescent layer, 7 the luminescent layer to which phenolic stabilizer (LL+S) has been added and 8 a layer of stabilizing material (SL) coating the luminescent layer. The samples produced for this study are listed in Table 1, where A stands for Alq3, B for BHT, * refers to Alq3 supplied by a different source, and % refers to sample structure 5b.

TABLE 1

| | | | Initial | Initial | E/A | E/t |
|---|---|---|---|---|---|---|
| Alq₃ | thickness t(nm) | Deposition | emission (E) | absorption (A) | (arb. | (arb. |
| sample | and composition | date | (arb. units) | (optical density) | units) | units) |
| 3-1 | 50 | Dec. 05, 2000 | 56 | 0.10 | 56 | 56 |
| | A | | | | | |
| 3-2 | 65 | Dec. 07, 2000 | 45 | 0.10 | 45 | 45 |
| | A + B | | | | | |
| 3-3 | 30 | Dec. 15, 2000 | 6.2 | 0.010 | 62 | 10 |
| | A + 5% B | | | | | |
| 3-4 | 100 | Dec. 20, 2000 | 8.3 | 0.025 | 34 | 4 |
| | A + 5% B | | | | | |
| 3-5 | 100 | Jan. 10, 2001 | 78 | 0.17 | 46 | 39 |
| | A(*) | | | | | |
| 3-6 | 30 | Jan. 16, 2001 | 30 | 0.055 | 55 | 50 |
| | A(*) | | | | | |
| 3-7 | 100 | Jan. 23, 2001 | 51 | 0.14 | 40 | 25 |
| | A* + 5% B | | | | | |
| 3-8 | 100 | Jan. 25, 2001 | 92 | 0.15 | 61 | 46 |
| | A* + 10% B | | | | | |
| 3-9 | 95 | Jan. 31, 2001 | 31 | 0.09 | 35 | 19 |
| | A* + B | | | | | |

These samples have been prepared by under vacuum thermal vaporization of Alq₃ and BHT powders contained in molybdenum crucibles whereas the substrates were kept at room temperature at about 10 cm distant from the crucible. In order to avoid an excessive dishomogeneity of the sample of FIG. 5b some experimental expedients have been utilized among which may be cited a long preheating of the well mixed powders just below the BHT melting temperature and a quick increase in the temperature up to the Alq₃ melting one. In this way the materials vaporize more or less at the same time thereby obtaining a sufficiently homogeneous film. On the contrary, the preparation of the devices of FIG. 5a and 5c has not had problems.

The film thickness is controlled both during growing (by means of the Thickness Monitor Varian model n. 985-7019) and after growing (with the profilometer Tencor Alphastep).

The absorption optical measurements have been performed with a Perkin-Elmer λ19 spectrophotometer. The light emission has been measured with a Jobin-Yvon Fluorolog-3 spectrofluorimeter in frontal geometry wherein both excitation at 395 nm and luminescence insist on the same side of the thin film with an angle between the geometrical axes of about 20°. All the measurements have been performed in air without any permanent protection of the thin film and at room temperature, and each of them has required about 5 minutes for the performance thereof. With the exclusion of the time during which measurements were performed and the time required to disassemble the just prepared film from the vaporization apparatus, about 5 minutes, all the films have been kept at room temperature in an anhydrous bell so as to avoid the continuous interaction with atmospheric humidity. It has been noted, in fact, that the just vaporized surface of an Alq₃ film is saturated by water in just 2 minutes in usual conditions of any laboratory and in time (more than some hours) this water induces the formation of not luminous crystalline structures. Only if the temperature exceeds 90° C. the water reacts with Alq₃ and it causes a quick degeneration of the material itself. Therefore in the methodologies followed in this study, one is in the best conditions to measure the effects of the atmospheric oxygen alone on the light properties of Alq₃ film pure and mixed with the BHT phenolic compound.

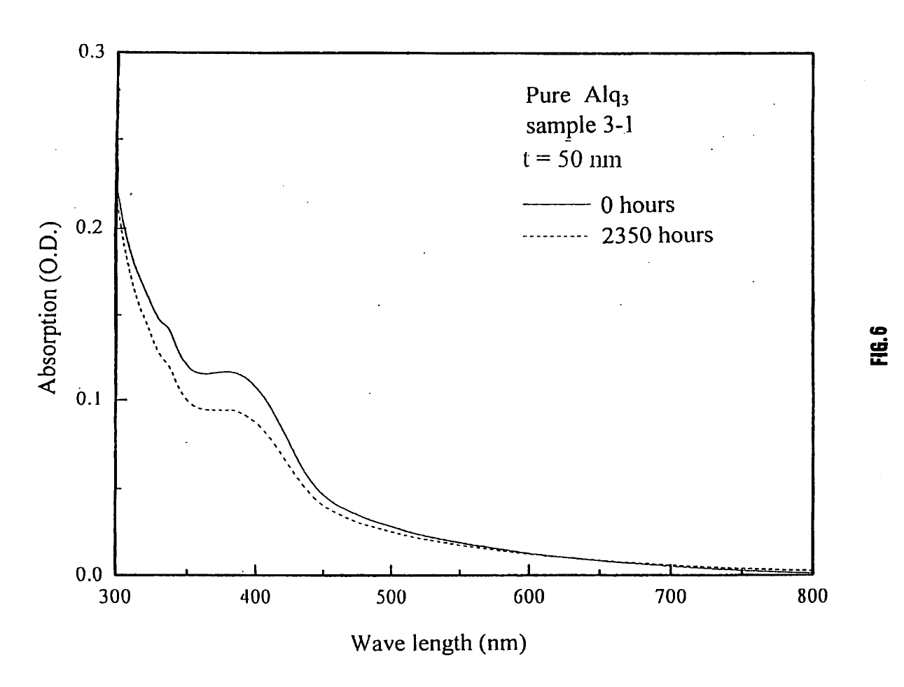

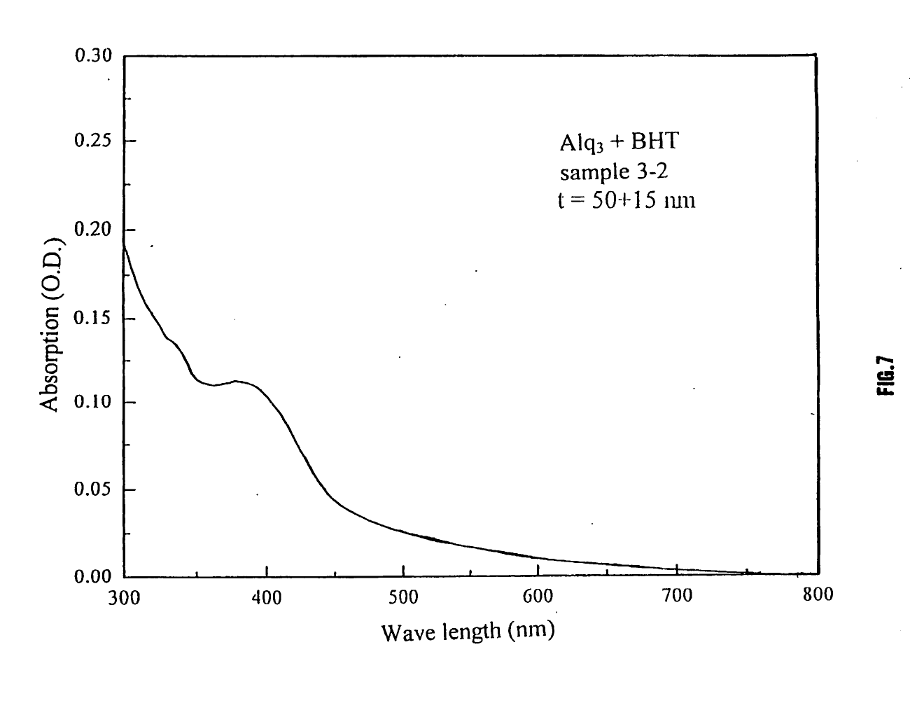

FIG. 6 shows two absorption spectra of the sample 3.1 of pure Alq₃, as in the scheme of FIG. 5b, measured in different times. FIG. 7 shows the absorption spectrum of the 50-nm thick Alq₃ sample 3-2 coated with 15 nm of BHT, as in the scheme of FIG. 5c. The absorption curve, taken at zero hours, is similar to the one shown in FIG. 6, and the importance thereof lies exactly in this similarity. In fact, it means that the BHT phenolic material does not have absorption bands at least in the same area of those of Alq₃.

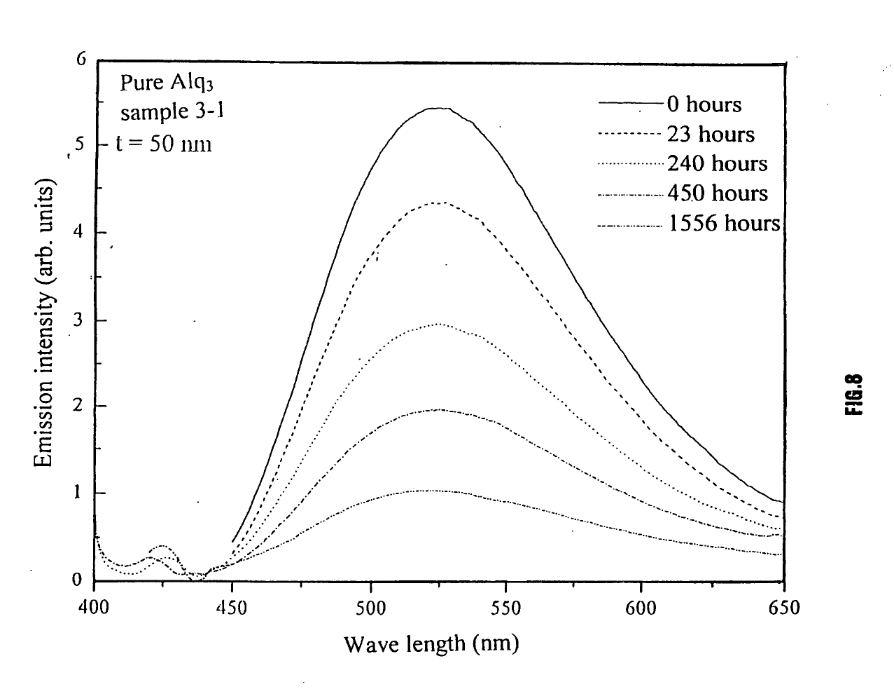

FIG. 8 shows the emission bands of the sample 3-1 of pure Alq₃ vs. time, as measured in the spectrofluorimeter. One notes immediately that the average life of the sample is little lower than 300 hours.

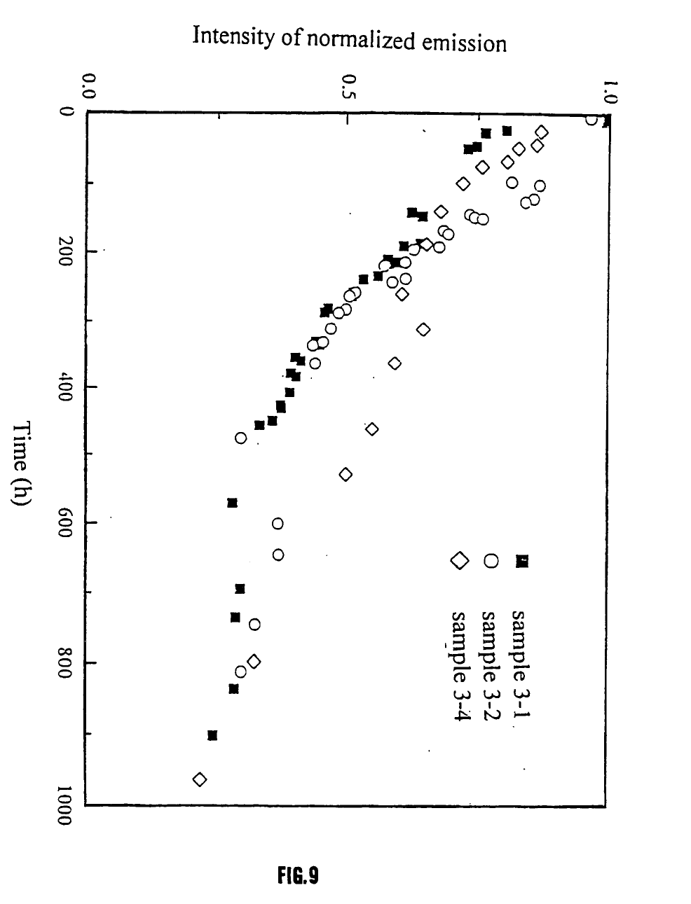

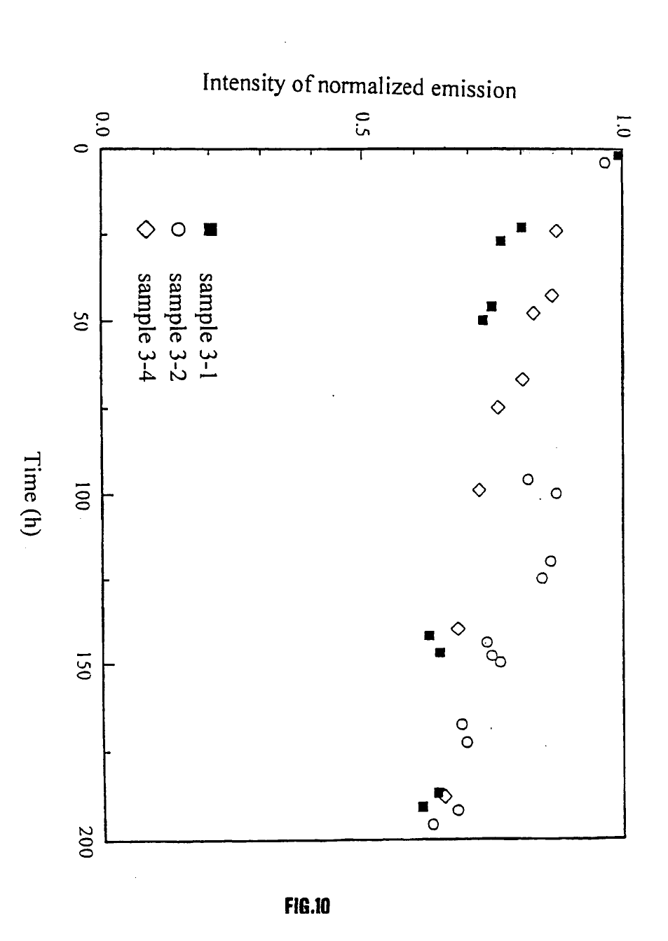

FIG. 9 shows the emission intensity measured at 528 nm vs. time of samples 3-1, 3-2 and 3-4, the latter constituted by a 100-nm thick Alq₃ layer mixed with 5% BHT, as in the scheme of FIG. 5b. It is evident that the time progresses of both samples protected by BHT are different from the one of pure Alq₃, the values thereof are always lower than the other two. In particular the sample 3-4 has an average life of about 500 hours, whereas both samples 3-4 and 3-2 have higher values than sample 3-1 in the first 200 hours. This property, which is a feature common to all the samples protected by BHT, that is 3-2, 3-3, 3-4, 3-7, 3-8, and 3-9, is made clear in FIG. 9, which refers to the first 200 life hours only, for the samples 3-2 and 3-4 compared to 3-1. In all probability, these first 200 hours correspond to the time required to atmospheric oxygen to spread in thin films and neutralize the BHT molecules.

These examples demonstrate that the luminescence intensity decreases in time probably to become null at infinite times. The association of organic materials such as those previously defined, Alq₃ in particular, with products of phenolic nature, BHT in particular, both mixed and stratified, demonstrates without any doubt that the luminescence intensity is greater than the Alq₃ samples both on medium-long time and short time.

It is to be stressed that among the materials of organic origin also organic polymers and not only molecules can be utilized, thereby extending the application scope of the present invention, invention which concerns both the so-called OLED (organic light emitting diodes) devices which utilized organic molecules to “produce” luminescence, and the devices with utilize the organic polymers, which are called PLED (polymer light emitting diodes). Therefore also the devices which utilize organic materials, both under the form of molecule and of polymer, stabilized with products of phenolic nature are further objects of the present invention.

1-17. (Canceled)

18. A composition comprising an organic material having luminescence, and a luminescence-stabilizing amount of a compound of phenolic origin.

19. The composition of claim 18 wherein said compound of phenolic origin comprises 1-10% by weight with reference to the weight of said organic material.

20. The composition of claim 18 wherein said organic material which possesses luminescence comprises an organic molecule or an organic polymer.

21. The composition according to claim 20 wherein said organic material is an organic molecule selected from the group consisting of Alq₃, tetracene, anthracene, carbazole, rubrene, TBD, PKV, DMC, α-6T, and Er(TTA)3(phen).

22. The composition according to claim 20, wherein said organic material is an organic polymer selected from the group consisting of P3AT, PPA, PPV, CN-PPV, MEH-PPV, RO-PPV, PPy, PT, PTV, PVK, and SiPhPVK.

23. The composition of claim 18 wherein said compound of phenolic origin is selected from the group consisting of BHT, phenol, vanillin, L-tyrosine, BHA, E vitamin, propyl gallate, 2,4,6-tri-t-butylphenol, hydroxytyrosole, and caffeic acid and does not have absorption bands in the same area as that of said organic material having luminescence.

24. A method for the stabilization of the luminescence from an organic material comprising:
mixing said organic material with a quantity ranging from 1 to 10% in weight of a compound of phenolic origin until obtaining a homogeneous composite material,
whereby said homogeneous composite material has stabilized luminescence.

25. The method according to claim 24, wherein said organic material is an organic molecule or an organic polymer.

26. The method according to claim 25, wherein said organic molecule is selected from the group consisting of Alq3, tetracene, anthracene, carbazole, rubrene, TBD, PKV, DMC, α-6T,Er(TTA)3(phen), etc. and said organic polymer is selected from the group consisting of P3AT, PPA, PPV, CN-PPV, MEH-PPV, RO-PPV, PPy, PT, PTV, PVK, and SiPhPVK.

27. The method according to claim 24, wherein said compound of phenolic origin is selected from the group consisting of phenol, vanillin, L-tyrosine, BHA, BHT, E vitamin, propyl gallate, 2,4,6-tri-t-butylphenol, hydroxytyrosole, and caffeic acid.

28. An organic material with stabilized luminescence obtainable by the method according to claim 24.

29. An OLED or PLED device containing a material according to claim 28.
